(19) United States
(12) Patent Application Publication
(10) Pub. No.: US 2020/0160518 A1
(43) Pub. Date: May 21, 2020

(54) DYNAMIC IMAGE ANALYSIS APPARATUS AND DYNAMIC IMAGE ANALYSIS SYSTEM

(71) Applicant: Konica Minolta, Inc., Tokyo (JP)

(72) Inventors: Noritsugu MATSUTANI, Tokyo (JP); Tohru TANI, Otsu-shi (JP)

(21) Appl. No.: 16/690,654

(22) Filed: Nov. 21, 2019

(30) Foreign Application Priority Data
Nov. 21, 2018 (JP) 2018-217827

(51) Int. Cl. G06T 7/00

(52) U.S. Cl. CPC G06T 7/0012; G06T 2207/30061; G06T 2207/30048

(57) ABSTRACT

A dynamic image analysis apparatus includes a hardware processor that extracts a heart region or a lung region from a dynamic image obtained by radiographing a dynamic state of a chest of a subject and calculates, based on an area, a diameter, or a pixel value of the extracted heart region or a pixel value of the extracted lung region, an evaluation value of a cardiac function or an evaluation value of a water content of the subject.

### CROSS-REFERENCE TO RELATED APPLICATION

The present invention claims priority under 35 U.S.C. § 119 to Japanese patent application No. 2018-217827 filed on Nov. 21, 2018, the entire contents of which are incorporated herein by reference.

### BACKGROUND

### Technological Field

The present invention relates to a dynamic image analysis apparatus and a dynamic image analysis system.

### Description of the Related Art

A pulmonary-artery catheter has been used in order to measure a cardiac function of a patient in a serious circulatory state such as a shock or a heart failure. However, the pulmonary-artery catheter has large invasiveness and therefore cannot be retained for a long period.

Therefore, for example, JP 2009-136573A (Patent Literature 1) states that a cardiac region of an object is dynamically radiographed and an evaluation value concerning a cardiac function is calculated using X-ray images in a plurality of time phases. Specifically, Patent Literature 1 states that a center of gravity of a pulsating part of the aorta is calculated, a movement amount in a unit time of the center of gravity is calculated as an evaluation value of a blood flow rate, the volume of the pulsating part is calculated as an evaluation value of a cardiac output, and a motion amount, an evaluation value of directionality, and an evaluation value of periodicity of a local part of the heart are calculated.

In the technique described in Patent Literature 1, the evaluation value of the cardiac function is calculated from the concentration and the shape of the pulsating part in the blood vessel and the local movement (the movement in a pixel unit) of the heart. However, from the viewpoint of a patient exposure reduction, in general, in radiographing of the dynamic radiographing, the radiographing is performed with a radiation dose further reduced than in still image radiographing. Therefore, image quality is deteriorated compared with a still image. When the cardiac function is evaluated on a real-time basis during an operation as in the case of the pulmonary-artery catheter, since a radiographing time is long, it is necessary to further reduce a radiation dose for each frame image. Therefore, the image quality is further deteriorated. It is difficult to accurately detect the concentration and the shape of the pulsating part in the blood vessel and the local movement of the heart from such a low-quality image. It is difficult to recognize a blood vessel such as the aorta because the blood vessel overlaps the thoracic vertebrae in front radiographing. Further, Patent Literature 1 does not state calculating an evaluation value of a water content of a subject from a dynamic image of the chest.

### SUMMARY

An object of the present invention is to make it possible to accurately calculate an evaluation value of a cardiac function or an evaluation value of a water content of a subject from a chest dynamic image.

In order to realize the object described above, a dynamic image analysis apparatus reflecting an aspect of the present invention includes a hardware processor that extracts a heart region or a lung region from a dynamic image obtained by radiographing a dynamic state of a chest of a subject and calculates, based on an area, a diameter, or a pixel value of the extracted heart region or a pixel value of the extracted lung region, an evaluation value of a cardiac function or an evaluation value of a water content of the subject.

A dynamic image analysis system reflecting an aspect of the present invention includes: the dynamic image analysis apparatus according to claim 1; and

a radiographing apparatus that radiographs the dynamic image.

### BRIEF DESCRIPTION OF THE DRAWINGS

The object, the effects, and the characteristics of the present invention described above will be more completely understood from the following detailed description and the accompanying drawings. However, the detailed description and the accompanying drawings do not limit the present invention, where:

FIG. 1 is a diagram showing an overall configuration of a dynamic image analysis system according to an embodiment;

FIG. 2 is a block diagram showing a functional configuration of a console shown in FIG. 1;

FIG. 3A is a scatter diagram showing a relation between the area of a heart region extracted from a chest dynamic image and a cardiac output;

FIG. 3B is a scatter diagram showing a relation between a pixel value in a lung region extracted from the chest dynamic image and the cardiac output;

FIG. 4 is a flowchart showing cardiac function measurement processing A executed by a controller shown in FIG. 2;

FIG. 5 is a diagram showing an example of the chest dynamic image;

FIG. 6 is a diagram showing a temporal change of a heart area in the chest dynamic image, a cardiac cycle, a maximum value, and a minimum value;

FIG. 7A is a scatter diagram showing a relation between the area of the heart region extracted from the chest dynamic image and a blood pressure;

FIG. 7B is a scatter diagram showing a relation between the pixel value in the lung region extracted from the chest dynamic image and the blood pressure;

FIG. 8A is a scatter diagram showing a relation between the area of the heart region extracted from the chest dynamic image and a pulmonary arterial pressure;

FIG. 8B is a scatter diagram showing a relation between the pixel value in the lung region extracted from the chest dynamic image and the pulmonary arterial pressure;

FIG. 9 is a flowchart showing cardiac function measurement processing B executed by the controller shown in FIG. 2; and

FIG. 10 is a diagram showing a division of the left heart and the right heart.

### DETAILED DESCRIPTION OF EMBODIMENTS

Preferred embodiments of the present invention are explained below with reference to the drawings. The present invention is not limited by illustrated examples.

### First Embodiment

### (Configuration of a Dynamic Image Analysis System 100)

First, the configuration of a first embodiment of the present invention is explained.

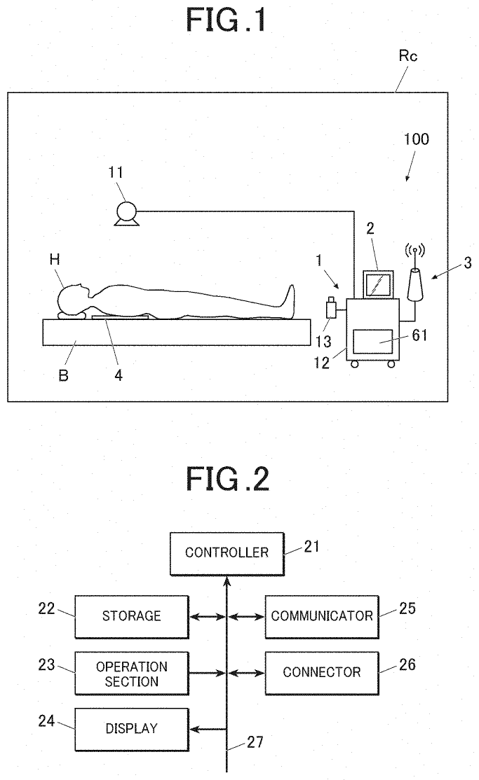

An overall configuration example of a dynamic image analysis system 100 in this embodiment is shown in FIG. 1.

The dynamic image analysis system 100 is a system for round visit for radiographing, as a subject, a patient having difficulty in movement who is present in, for example, an intensive care unit or an operating room. The dynamic image analysis system 100 includes a radiation generator 1, a console 2, an access point 3, and an FPD (Flat Panel Detector) cassette 4. The radiation generator 1 includes wheels and is configured as a movable round visit car on which the console 2 and the access point 3 are set. In the dynamic image analysis system 100, the console 2 is communicatively connectable to the radiation generator 1 and the FPD cassette 4 via the access point 3.

The dynamic image analysis system 100 is, as shown in FIG. 1, a system that is taken into an operating room (an intensive care unit) Rc or the like, irradiates radiation from a portable radiation source 11 of the radiation generator 1, and performs dynamic radiographing of a subject H (a test object) in a state in which, for example, the FPD cassette 4 is inserted between the subject H lying on a bed B and the bed B or is inserted into an insertion port provided on a not-shown surface of the bed B opposite to the subject H.

The dynamic radiographing refers to acquiring a plurality of images by repeatedly irradiating radiation such as an X ray on the subject H in a pulse state at a predetermined time interval (pulse irradiation) or intermittently continuously irradiating the radiation at a low dosage rate (continuous irradiation). In the dynamic radiographing, for example, dynamic states of the subject H having periodicity (cycles) such as a form change of expansion and contraction of the lung involved in a respiratory movement and beating of the heart. A series of images obtained by the continuous radiographing is called dynamic image. Each of a plurality of images forming the dynamic image is called frame image.

In this embodiment, the dynamic image analysis system 100 is explained as radiographing a dynamic state of the chest front of the subject H.

Apparatuses configuring the dynamic image analysis system 100 are explained below.

The radiation generator 1 is a radiation generator capable of performing at least one of the pulse irradiation and the continuous irradiation. The radiation generator 1 includes the radiation source 11 that irradiate radiation, a radiation irradiation controller 12, and an exposure switch 13.

The radiation source 11 irradiates radiation (an X ray) on the subject H according to control by the radiation irradiation controller 12.

The radiation irradiation controller 12 controls the radiation source 11 based on radiation irradiation conditions transmitted from the console 2 to perform radiographing. The radiation irradiation conditions input from the console 2 are, for example, a tube current, a tube voltage, a frame rate (the number of frame images radiographed per one unit time (one second)), a total radiographing time or a total number of radiographed frame images per one radiographing, an additional filter type, and, in the case of the pulse irradiation, a radiation irradiation time per one frame image.

The exposure switch 13 inputs a radiation irradiation instruction signal into the console 2 by being pressed.

The console 2 outputs the radiation irradiation conditions to the radiation generator 1 and outputs image reading conditions to the FPD cassette 4 to control radiographing and a reading operation of a radiograph, calculates a stroke volume (SV) and a cardiac output (OC) as evaluation values of a cardiac function of the subject H based on a chest dynamic image transmitted from the FPD cassette 4, and displays a calculation result.

A functional configuration example of the console 2 is shown in FIG. 2. As shown in FIG. 2, the console 2 includes a controller 21, a storage 22, an operation section 23, a display 24, a communicator 25, and a connector 26. These sections are connected by a bus 27.

The controller 21 is configured by a CPU (Central Processing Unit), a RAM (Random Access Memory), and the like. The CPU of the controller 21 reads out a system program and various processing programs stored in the storage 22 and develops the programs in the RAM according to operation of the operation section 23 and centrally controls the operations of the sections of the console 2 and the operations of the radiation generator 1 and the FPD cassette 4 according to the developed programs.

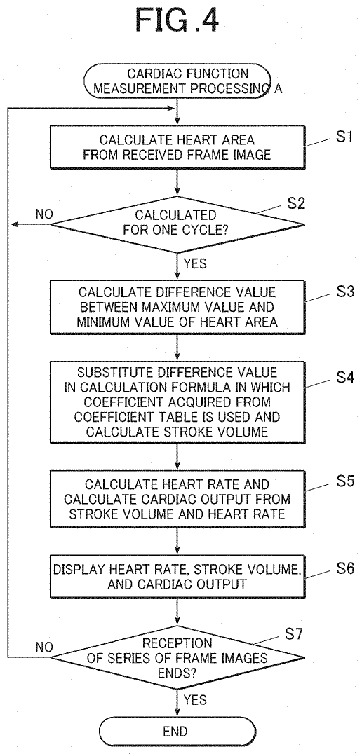

The storage 22 is configured by a nonvolatile semiconductor memory, a hard disk, or the like. The storage 22 stores various programs executed by the controller 21 and parameters necessary for execution of processing by the programs or data such as processing results. For example, the storage 22 has stored therein a program for executing cardiac function measurement processing A shown in FIG. 4. The various programs are stored in a form of readable program codes. The controller 21 sequentially executes operations conforming to the program codes.

The storage 22 has stored therein radiation irradiation conditions during dynamic radiographing and image reading conditions. A user can set the radiation irradiation conditions and the image reading conditions by operating the operation section 23.

The storage 22 has stored therein a coefficient table that stores, for each combination of an age and a physique (for example, height and/or weight), a coefficient used in a calculation formula (a linear formula) for calculating a stroke volume from a difference value between a maximum value and a minimum value in one cardiac cycle of a heart area of a chest dynamic image.

The coefficients stored in the coefficient table are experimentally calculated coefficients.

The operation section 23 includes a keyboard including a cursor key, number input keys, and various function keys and a pointing device such as a mouse. The operation section 23 outputs, to the controller 21, an instruction signal input by key operation on the keyboard or mouse operation. The operation section 23 may include a touch panel on a display screen of the display 24. In this case, the operation section 23 outputs, to the controller 21, an instruction signal input via the touch panel.

The display 24 is configured by a monitor such as an LCD (Liquid Crystal Display) or a CRT (Cathode Ray Tube). The display 24 displays an input instruction from the operation section 23, data, and the like according to an instruction of a display signal input from the controller 21.

The communicator 25 includes a wireless LAN adapter and controls data transmission and reception to and from external devices such as the radiation generator 1 and the FPD cassette 4 connected to a communication network such as a wireless LAN via the access point 3.

The connector 26 is a connector for performing communicative connection to the FPD cassette 4 via a not-shown cable.

Referring back to FIG. 1, the access point 3 relays communication between the radiation generator 1 and the console 2, communication between the console 2 and the FPD cassette 4, and the like.

The FPD cassette 4 is a portable radiation detector adapted to dynamic radiographing. The FPD cassette 4 is configured by arraying, in a predetermined position on a substrate such as a glass substrate, in a matrix shape (a two-dimensional shape), a plurality of radiation detecting elements that detect radiation irradiated from the radiation source 11 and transmitted through at least the subject H according to the intensity of the radiation, converts the detected radiation into an electric signal, and accumulates the electric signal. A switcher such as a TFT (Thin Film Transistor) is connected to the radiation detecting elements. Accumulation of electric signals in the radiation detecting elements and reading of the electric signals are controlled by the switcher and image data (a frame image) is acquired. As the FPD, there are an indirect conversion type that converts radiation into an electric signal with a photoelectric conversion element via a scintillator and a direct conversion type that directly convers radiation into an electric signal. Any of the indirect conversion type and the direct conversion type may be used.

The FPD cassette 4 includes a reading controller that controls accumulation and reading of electric signals by the switcher and a communicator for performing communicative connection to the console 2 via the access point 3 (both of the reading controller and the communicator are not shown in FIG. 1). Image reading conditions such as a frame rate, the number of radiographed frame images per one radiographing, and an image size (a matrix size) are set by the console 2 via the communicator. The reading controller controls accumulation and reading of electric signals in and from the radiation detecting elements by the switcher based on the set image reading conditions. The FPD cassette 4 includes a connector and is communicatively connectable to the console 2 via a not-shown cable.

A radiographing practitioner such as a radiologist may carry the FPD cassette 4. However, the FPD cassette 4 is relatively heavy and is likely to be broken or break down if dropped. Therefore, the FPD cassette 4 can be conveyed by being inserted into a pocket 61a for a cassette provided in a round visit car.

### (Operation of the Dynamic Image Analysis System 100)

The operation in the dynamic image analysis system 100 is explained.

First, the radiographing practitioner inputs patient information (a name, an age, sex, a physique, and the like) of the subject H and test information (a test target part (the chest), test year, month and date, and the like) with the operation section 23 of the console 2 and sets the radiation source 11 and the FPD cassette 4 in predetermined positions.

The controller 21 of the console 2 sets, in the radiation irradiation controller 12, radiation irradiation conditions corresponding to the test target part (the chest) and sets image reading conditions in the FPD cassette 4.

When the exposure switch 13 is pressed, the controller 21 controls the radiation irradiation controller 12 and the FPD cassette 4 to perform dynamic radiographing of the chest of the subject H. The FPD cassette 4 sequentially transmits frame images acquired by the radiographing to the console 2.

In the console 2, when reception of frame images of a chest dynamic image transmitted from the FPD cassette 4 is started, the cardiac function measurement processing A is started.

The inventor measured, concerning a large number of subjects, cardiac outputs with a method such as a thermodilution method using a pulmonary-artery catheter, calculated a heart area from a chest dynamic image during the measurement, and examined a relation between the cardiac output and the heart area. The inventor extracted a lung region from the chest dynamic image during the measurement and examined a relation between the cardiac output and an average pixel value in the lung region. The inventor extracted a heart region from the chest dynamic image during the measurement and examined a relation between the cardiac output and an average pixel value in the heart region. The inventor calculated a diameter of the heart region (for example, a maximum diameter in the horizontal direction of the heart region; the same applies below) from the chest dynamic image during the measurement and examined a relation between the cardiac output and the diameter of the heart. The inventor performed the examination by grouping the subjects according to ages and physiques of the subjects.

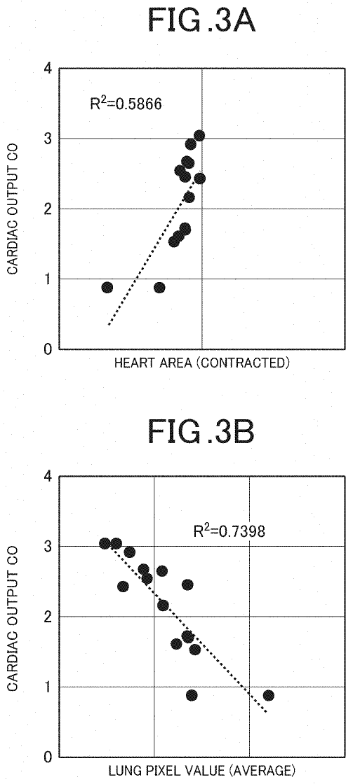

FIG. 3A is a scatter diagram created as an example of the examination and showing a relation between a heart area of a chest dynamic image (a frame image) radiographed in a systole period (indicating a phase in which the heart contracts most among cardiac phases; the same applies below) and a cardiac output. FIG. 3B is a scatter diagram showing a relation between an average in one respiratory cycle of an average pixel value in the lung region of the chest dynamic image and the cardiac output. As shown in FIG. 3A and FIG. 3B, the heart area and the average pixel value of the lung region respectively have high correlations with the cardiac output. Relations between the heart area and the average pixel value of the lung region and the cardiac output can be represented by linear formulas.

In FIG. 3A, the relation between the heart area of the chest dynamic image (the frame image) radiographed in the systole period and the cardiac output is shown as an example. However, as a result of the examination, it has been found that a relation between a heart area calculated from a chest dynamic image (a frame image) radiographed in a predetermined cardiac phase (for example, the systole period or a diastole period (indicating a phase in which the heart expands most among the cardiac phases; the same applies below)) and the cardiac output, a relation between a difference value between a maximum value and a minimum value in one cardiac cycle of the heart area calculated from the chest dynamic image and the cardiac output, and a relation between an average in one cardiac cycle of the heart area calculated from the chest dynamic image and the cardiac output can also be represented by linear formulas. As a result of, concerning a large number of subjects, calculating a stroke volume from a cardiac output measured by the thermodilution method or the like and examining the stroke volume, it has been found that a relation between a heart area calculated from a chest dynamic image (a frame image) radiographed in a predetermined cardiac phase and the stroke volume, a relation between a difference value between a maximum value and a minimum value in one cardiac cycle of the heart area calculated from the chest dynamic image and the stroke volume, and a relation between an average in one cardiac cycle of the heart area calculated from the chest dynamic image and the cardiac output can also be represented by linear formulas. However, coefficients of the linear formulas were different from one another.

In FIG. 3B, the relation between the average in one respiratory period of the average pixel value in the lung region calculated from the chest dynamic image and the cardiac output is shown as an example. However, as a result of the examination, it has been found that a relation between an average pixel value in the lung region calculated from a chest dynamic image (a frame image) radiographed in a predetermined respiratory phase and the cardiac output and a relation between a difference value between a maximum value and a minimum value in one respiratory period of the average pixel value in the lung region calculated from the chest dynamic image and the cardiac output can also be represented by linear formulas. As a result of, concerning a large number of subjects, calculating a stroke volume from a cardiac output measured by the thermodilution method or the like and examining the stroke volume, it has been found that a relation between an average in one respiratory period of an average pixel value in the lung region calculated from the chest dynamic image and the stroke volume, a relation between an average pixel value in the lung region calculated from a chest dynamic image (a frame image) radiographed in a predetermined respiratory phase and the stroke volume, and a relation between a difference value between a maximum value and a minimum value in one respiratory period of an average pixel value in the lung region calculated from the chest dynamic image and the stroke volume can also be represented by linear formulas. However, coefficients of the linear formulas were different from one another.

Similarly, as a result of the examination, it has been found that a relation between an average in one cardiac cycle of an average pixel value in the heart region calculated from the chest dynamic image and the cardiac output, a relation between an average pixel value in the heart region calculated from a chest dynamic image (a frame image) radiographed in a predetermined cardiac phase and the cardiac output, and a relation between a difference value between a maximum value and a minimum value in one cardiac cycle of the average pixel value in the heart region calculated from the chest dynamic image and the cardiac output can also be respectively represented by linear formulas. As a result of, concerning a large number of subjects, calculating a stroke volume from a cardiac output measured by the thermodilution method or the like and examining the stroke volume, it has been found that a relation between an average of an average pixel value in the heart region in one cardiac cycle and the stroke volume, a relation between an average pixel value in the heart region calculated from a chest dynamic image (a frame image) radiographed in a predetermined cardiac phase and the stroke volume, and a relation between a difference value between a maximum value and a minimum value of the average pixel value in the heart region in one cardiac cycle and the stroke volume can also be represented by linear formulas. However, coefficients of the linear formulas were different from one another.

It has been found that a relation between a diameter (for example, a maximum of a diameter in the horizontal direction) of the heart region of a chest dynamic image (a frame image) radiographed in a predetermined cardiac phase and the cardiac output, a relation between a difference value between a maximum value and a minimum value in one cardiac cycle of a diameter of the heart region calculated from the chest dynamic image and the cardiac output, and a relation between an average in one cardiac cycle of the diameter of the heart region calculated from the chest dynamic image and the cardiac output can also be represented by linear formulas. As a result of, concerning a large number of subjects, calculating a stroke volume from a cardiac output measured by the thermodilution method or the like and examining the stroke volume, it has been found that a relation between a diameter of the heart region of a chest dynamic image (a frame image) radiographed in a predetermined cardiac phase and the stroke volume, a relation between a difference value between a maximum value and a minimum value in one cardiac cycle of the diameter of the heart region calculated from the chest dynamic image and the stroke volume, and a relation between an average in one cardiac cycle of the diameter of the heart region calculated from the chest dynamic image and the stroke volume can also be represented by linear formulas. However, coefficients of the linear formulas were different from one another.

The console 2 calculates, based on these examination results, a stroke volume and a cardiac output from the chest dynamic image. In this embodiment, as an example, the cardiac function measurement processing A for calculating a stroke volume and a cardiac output using, as a parameter, a difference value between a maximum value and a minimum value in one cardiac cycle of a heart area calculated from the chest dynamic image is explained.

A flow of the cardiac function measurement processing A executed by the console 2 is shown in FIG. 4. The cardiac function measurement processing A is executed by cooperation of the controller 21 and the programs stored in the storage 22.

First, the controller 21 calculates a heart area from a received frame image (step S1).

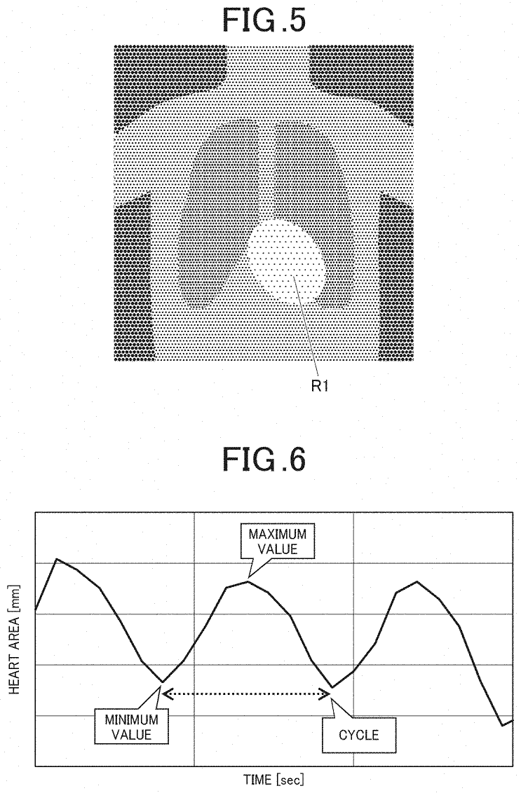

FIG. 5 is a diagram schematically showing a frame image of a chest dynamic image. As shown in FIG. 5, in a dynamic image of a chest front, the heart (a region indicated by R1 in FIG. 5) is drawn as a substantially elliptical region.

In step S1, first, the controller 21 extracts a heart region from the received frame image. The extraction of the heart region is not particularly limited. For example, the extraction of the heart region can be performed using template matching processing. For example, a template image of the heart is stored in the storage 22. The controller 21 calculates a similarity degree of the template image and a portion overlapping the template image while moving the template image in the frame image and extracts a region having the highest similarity degree as the heart region. The similarity degree can be calculated using, for example, an SSD (Sum of Squared Difference) or a SAD (Sum of Absolute Difference). Subsequently, the controller 21 can calculate a heart area by counting the number of pixels of the calculated heart region and multiplying the number of pixels by a pixel size.

Subsequently, the controller 21 determines based on a temporal change of the calculated heart area whether a heart area of a frame image for one cardiac cycle has been calculated (step S2). If determining that the heart area of the frame image for one cardiac cycle has not been calculated (NO in step S2), the controller 21 returns to step S1.

If determining that the heart area for one cardiac cycle has been calculated (YES in step S2), as shown in FIG. 6, the controller 21 calculates a maximum value and a minimum value of the acquired heart area for the cycle and calculates a difference value between the maximum value and the minimum value (step S3).

Subsequently, the controller 21 acquires a coefficient corresponding to the age and the physique of the subject H from the coefficient table stored in the storage 22, substitutes the difference value calculated in step S3 in a calculation formula (a linear formula) in which the acquired coefficient is used, and calculates a stroke volume of the heart of the subject H (step S4).

Subsequently, the controller 21 calculates a heart rate and calculates a cardiac output from the stroke volume and the heart rate (step S5).

First, the controller 21 calculates a cycle [sec] of a temporal change of the heart area. The cycle is equivalent to the cardiac cycle. Subsequently, the controller 21 calculates a heart rate according to Expression 1.

Heart rate=60÷cycle [sec] (Expression 1)

Subsequently, the controller 21 calculates a cardiac output according to the following Expression 2.

Cardiac output=stroke volume×heart rate (Expression 2)

The calculated heart rate, the calculated stroke volume, and the calculated cardiac output are desirably normalized by a correction coefficient based on a heart area or a lung area calculated from the chest dynamic image or the height or the weight of the subject H.

Subsequently, the controller 21 displays the calculated heart rate, the calculated stroke volume, and the calculated cardiac output on the display 24 (step S6).

In this embodiment, every time a frame image for one cardiac cycle is received from the FPD cassette 4, a heart rate, a stroke volume, and a cardiac output are calculated and displayed on the display 24 (the display is updated). That is, the heart rate, the stroke volume, and the cardiac output can be measured and displayed substantially on a real-time basis.

As a display example in step S6, for example, the controller 21 sequentially displays received frame images and displays the calculated latest heart rate, the calculated latest stroke volume, and the calculated latest cardiac output as numerical values. Alternatively, the controller 21 may display the calculated heart rate, the calculated stroke volume, and the calculated cardiac output respectively as time-series graphs. Alternatively, the controller 21 may display the heart region of the displayed frame image in a color corresponding to a value of the heart rate, the stroke volume, or the cardiac output. The user may be able to set which of the heart rate, the stroke volume, and the cardiac output is displayed.

Subsequently, the controller 21 determines whether reception of a series of frame images of a dynamic image from the FPD cassette 4 has ended (step S7). For example, when a transmission end of the frame images of the dynamic image is notified from the FPD cassette 4, the controller 21 determines that the reception of the series of frame images of the dynamic image has ended.

If determining that the reception of the series of frame images of the dynamic image has not ended (NO in step S7), the controller 21 returns to step S1.

If determining that the reception of the series of frame images of the dynamic image has ended (YES in step S7), the controller 21 ends the cardiac function measurement processing A.

In this way, in the cardiac function measurement processing A, the controller 21 extracts a heart region from the frame images of the chest dynamic image, calculates a stroke volume by substituting a heart area calculated from the extracted heart region in a calculation formula in which a coefficient corresponding to the age and the physique of the subject H is used, and calculates a cardiac output based on the stroke volume and a heart rate calculated from a temporal change of the heart area. Therefore, rather than detecting a hardly recognizable microstructure such as a pulsating part in a vessel or a local portion of the heart from the frame images of the chest dynamic image and using a measurement value and a pixel value of the microstructure as in the past, the heart rate, the stroke volume, and the cardiac output are calculated using the area of an easily recognizable heart region. Therefore, it is possible to accurately calculate the heart rate, the stroke volume, and the cardiac output.

In the cardiac function measurement processing A, an example is explained in which a difference value of a maximum value and a minimum value of a heart area is calculated for each one cardiac cycle from the frame images of the chest dynamic image sequentially transmitted from the FPD cassette 4, a stroke volume is calculated using the calculated difference value, and a cardiac output is calculated from the stroke volume and a heart rate. However, a parameter for calculating the stroke volume and the cardiac output is not limited to the difference value. For example, a coefficient used in a calculation formula for calculating a stroke volume from a value of any one of the following parameters calculated from the chest dynamic image and verified by an experiment may be stored in the coefficient table of the storage 22. The controller 21 may acquire a coefficient corresponding to the patient information of the subject H from the coefficient table of the storage 22 and calculate a stroke volume by substituting the value of the parameter calculated from the chest dynamic image in a calculation formula in which the acquired a coefficient is used. The controller 21 may calculate a cardiac output from the calculated stroke volume and a heart rate. Alternatively, a coefficient used in a calculation formula for calculating each of a stroke volume and a cardiac output from a value of any one of the following parameters may be stored in the coefficient table of the storage 22. The controller 21 may acquire a coefficient corresponding to the patient information of the subject H from the coefficient table of the storage 22 and calculate a stroke volume and a cardiac output by substituting the value of the parameter calculated from the chest dynamic image in the calculation formula in which the acquired coefficient is used.

The following parameters are calculated from an area, a diameter, a pixel value of a heart region or a pixel value of a lung region easily recognizable from a frame image. Since the calculation of the parameters does not involve extraction and recognition of a microstructure, it is possible to accurately calculate a stroke volume and a cardiac output.

When a parameter based on the heart area or the pixel value of the heart region is used, in order to reduce an error due to a body motion or respiration, when performing dynamic radiographing, it is desirable to instruct the subject H to hold breath and perform the dynamic radiographing in a breath-held state.

### <Parameter Examples>

A heart area in a predetermined cardiac phase (for example, a systole period, a diastole period, or an intermediate period of the systole period and the diastole period)
An average value in one cardiac cycle of the heart area
An average in one respiratory cycle of an average pixel value in the lung region
An average pixel value in the lung region in a predetermined respiratory phase (for example, a maximum expiratory level, a maximum inspiratory level, and an intermediate level between the maximum expiratory level and the maximum inspiratory level)
A difference value between a maximum value and a minimum value in one respiratory cycle of the average pixel value in the lung region
An average in one cardiac cycle of an average pixel value in the heart region
An average pixel value in the heart region of a predetermined cardiac phase (for example, a systole period, a diastole period, and an intermediate period between the systole period and the diastole period)
A difference value between a maximum value and a minimum value in one cardiac period of the average pixel value in the heart region
An average in one cardiac cycle of the diameter of the heart region
A diameter of the heart region in a predetermined cardiac phase (for example, a systole period, a diastole period, and an intermediate period between the systole period and the diastole period)
A difference value in one cardiac cycle between a maximum value and a minimum value of the diameter of the heart region

In the first embodiment, the coefficient used in the calculation formula for calculating an evaluation value of a cardiac function is experimentally calculated in advance and stored in the storage 22. However, a cardia output may be measured from a subject by another method such as the thermodilution method immediately before calculating a stroke volume. A coefficient may be calculated based on the measured cardiac output and a parameter (the area, the diameter and the pixel value of the heart region or the pixel value of the lung region) calculated from the frame image of the chest dynamic image during the measurement. For example, since cardiac output=stroke volume×heart rate from Expression 2,

Cardiac output=parameter×coefficient×heart rate (Expression 3)

Accordingly, the coefficient can be calculated by Expression 4.

Coefficient=cardiac output÷(parameter×heart rate) (Expression 4)

### Second Embodiment

A second embodiment of the present invention is explained.

In the first embodiment, the heart rate, the stroke volume, and the cardiac output are calculated as the evaluation values of the cardiac function based on the heart area calculated from the chest dynamic image. However, in the second embodiment, as an example, a blood pressure (BP), a pulmonary arterial pressure (PAP), an arterial pressure (AP), and a central venous pressure are calculated based on the pixel value in the lung region calculated from the chest dynamic image as evaluation values of the cardiac function and a lung water content and a whole body water content are calculated as evaluation values of a water content of the subject H.

In the second embodiment, a program for executing cardiac function measurement processing B explained below is stored in the storage 22. In the storage 22, for each combination of an age and a physique (for example, height and/or weight), a coefficient (a coefficient for blood pressure measurement) used in a calculation formula (a linear formula) for calculating a blood pressure from an average in one respiratory cycle of an average pixel value in the lung region in the chest dynamic image, a coefficient (a coefficient for pulmonary arterial pressure measurement) used in a calculation formula (a linear formula) for calculating a pulmonary arterial pressure, a coefficient (a coefficient for arterial pressure measurement) used in a calculation formula (a linear formula) for calculating an arterial pressure, a coefficient (a coefficient for central venous pressure measurement) used in a calculation formula (a linear formula) for calculating a central venous pressure, a coefficient (a coefficient for lung water content measurement) used in a calculation formula (a linear formula) for calculating a lung water content, and a coefficient (a coefficient for whole body water content measurement) used in a calculation formula (a linear formula) for calculating a whole body water content are respectively stored.

The other components of the dynamic image analysis system 100 in the second embodiment are the same as the components explained in the first embodiment. Therefore, the explanation in the first embodiment is applied. Operation for radiographing a chest dynamic image in the dynamic image analysis system 100 is also the same as the operation explained in the first embodiment. Therefore, the explanation in the first embodiment is applied. In the following explanation, the cardiac function measurement processing B started in the console 2 when reception of a frame image of a chest dynamic image from the FPD cassette 4 is started is explained.

Concerning a large number of subjects, the inventor measured a blood pressure with a manometer, calculated a heart area from a chest dynamic image during the measurement, and examined a relation between the blood pressure and the heart area. The inventor extracted a lung region from the chest dynamic image during the measurement and examined a relation between the blood pressure and an average pixel value in the lung region. The inventor extracted a heart region from the chest dynamic image during the measurement and examined a relation between the blood pressure and an average pixel value in the heart region. The inventor calculated a diameter of the heart from the chest dynamic image during the measurement and examined a relation between the blood pressure and the diameter of the heart region. The inventor performed the examination by grouping the subjects according to ages and physiques of the subjects.

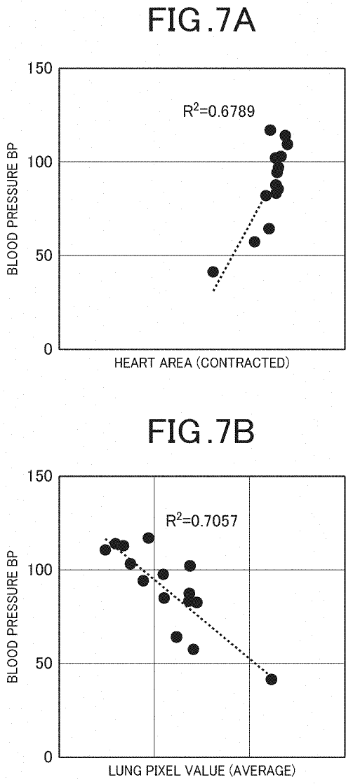

FIG. 7A is a scatter diagram showing, as an example of the examination, a relation between a heart area of a chest dynamic image (a frame image) radiographed in a systole period and a blood pressure. FIG. 7B is a scatter diagram showing a relation between an average in one respiratory cycle of an average pixel value in the lung region of the chest dynamic image and the blood pressure. As shown in FIG. 7A and FIG. 7B, the heart area and the average pixel value in the lung region respectively have high correlations with the blood pressure. Relations between the heart area and the average pixel value and the blood pressure can be represented by linear formulas.

In FIG. 7A, the relation between the heart area of the chest dynamic image (the frame image) radiographed in the systole period and the blood pressure is shown as an example. However, as a result of the examination, it has been found that a relation between a heart area calculated from a chest dynamic image (a frame image) radiographed in a predetermined cardiac phase and the blood pressure, a relation between a difference value between a maximum value and a minimum value in one cardiac cycle of the heart area and the blood pressure, and a relation between an average in one cardiac cycle of the heart area and the blood pressure can also be represented by linear formulas. However, coefficients of the linear formulas were different from one another.

In FIG. 7B, the relation between the average in one respiratory cycle of the average pixel value in the lung region of the chest dynamic image and the blood pressure is shown as an example. However, as a result of the examination, it has been found that a relation between an average pixel value in the lung region calculated from a chest dynamic image (a frame image) radiographed in a predetermined respiratory phase and the blood pressure and a relation between a difference value between a maximum value and a minimum value in one respiratory cycle of the average pixel value in the lung region and the blood pressure can also be represented by linear formulas. However, coefficients of the linear formulas were different from one another.

Similarly, as a result of the examination, it has been found that a relation between an average in one cardiac cycle of the average pixel value in the heart region of the chest dynamic region and the blood pressure, a relation between an average pixel value in the heart region calculated from a chest dynamic image (a frame image) radiographed in a predetermined cardiac phase and the blood pressure, and a relation between a difference value between a maximum value and a minimum value in one cardiac cycle of the average pixel value in the heart region and the blood pressure can also be represented by linear formulas. However, coefficients of the linear formulas were different from one another.

Similarly, as a result of the examination, it has been found that a relation between a diameter (for example, a maximum of a diameter in the horizontal direction) of the heart region of a chest dynamic image (a frame image) radiographed in a predetermined cardiac phase and the blood pressure, a relation between a difference value between a maximum value and a minimum value in one cardiac cycle of the diameter of the heart region in the chest dynamic image and the blood pressure, and a relation between an average in one cardiac cycle of the diameter of the heart region and the blood pressure can also be represented by linear formulas. However, coefficients of the linear formulas were different from one another.

Similarly, concerning a large number of subjects, the inventor respectively measured a pulmonary arterial pressure, an arterial pressure, a central venous pressure, a lung water content, and a whole body water content, calculates a heart area from a chest dynamic image during the measurement, and examined a relation between each of the pulmonary arterial pressure, the arterial pressure, the central venous pressure, the lung water content, and the whole body water content and the heart area. The inventor extracted a lung region from the chest dynamic image during the measurement and examined a relation between each of the pulmonary arterial pressure, the arterial pressure, the central venous pressure, the lung water content, and the whole body water content and an average pixel value in the lung region. The inventor extracted a heart region from the chest dynamic image during the measurement and examined a relation between each of the pulmonary arterial pressure, the arterial pressure, the central venous pressure, the lung water content, and the whole body water content and an average pixel value in the heart region. The inventor calculated a diameter of the heart from the chest dynamic image during the measurement and examined a relation between each of the pulmonary arterial pressure, the arterial pressure, the central venous pressure, the lung water content, and the whole body water content and the diameter of the heart. The inventor performed the examination by grouping the subjects according to ages and physiques of the subjects. The inventor measured the pulmonary arterial pressure with a pulmonary-artery catheter or the like and measured the arterial pressure and the lung water content with a circulation dynamic monitor or the like. The inventor measured the central venous pressure with a central venous catheter. The inventor judged the whole body water content from a transfusion amount, a urine amount, and a bleeding amount.

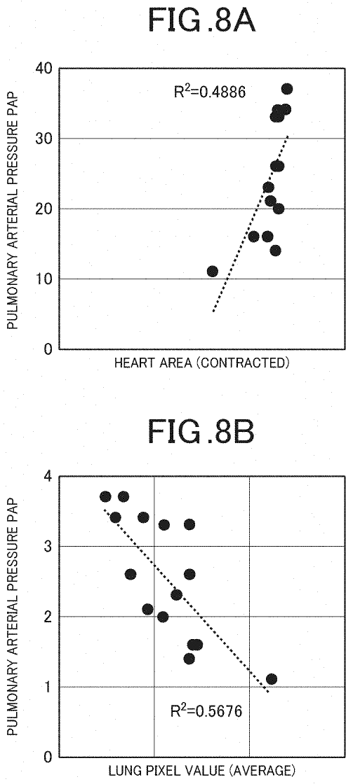

FIG. 8A is a scatter diagram showing, as an example of the examination, a relation between a heart area of a chest dynamic image (a frame image) radiographed in a systole period and a pulmonary arterial pressure. FIG. 8B is a scatter diagram showing a relation between an average in one respiratory cycle of an average pixel value in the lung region of a chest dynamic image and the pulmonary arterial pressure. As shown in FIG. 8A and FIG. 8B, the heart area and the average pixel value in the lung region respectively have high correlations with the pulmonary arterial pressure. Relations between the heart area and the average pixel value in the lung region respectively have high correlations with the pulmonary dynamic pressure. Relations between the heart area and the average pixel value in the lung region and the pulmonary arterial pressure can be represented by linear formulas.

In FIG. 8A, the relation between the heart area of the chest dynamic image (the frame image) radiographed in the systole period and the pulmonary arterial pressure is shown as an example. However, as a result of the examination, it has been found that a relation between a heart area calculated from a chest dynamic image (a frame image) radiographed in a predetermined cardiac phase and the pulmonary arterial pressure, a relation between a difference value between a maximum value and a minimum value in one cardiac cycle of a heart area of a chest dynamic image and the pulmonary arterial pressure, and a relation between an average in one cardiac cycle of the heart area and the pulmonary arterial pressure can also be represented by linear formulas. The same held true concerning the arterial pressure, the central venous pressure, the lung water content, and the whole body water content. However, coefficients of the linear formulas were different from one another.

In FIG. 8B, the relation between the average in one respiratory cycle of the average pixel value in the lung region of the chest dynamic image and the pulmonary arterial pressure is shown as an example. However, as a result of the examination, it has been found that a relation between an average pixel value in the lung region calculated from a chest dynamic image (a frame image) radiographed in a predetermined respiratory phase and the pulmonary arterial pressure and a relation between a difference value between a maximum value and a minimum value in one respiratory cycle of an average pixel value in the lung region of the chest dynamic image and the pulmonary arterial pressure can also be represented by linear formulas. The same held true concerning the arterial pressure, the central venous pressure, the lung water content, and the whole body water content. However, coefficients of the linear formulas were different from one another.

Similarly, as a result of the examination, it has been found that a relation between an average in one cardiac cycle of an average pixel value in the heart region of the chest dynamic image and each of the pulmonary arterial pressure, the arterial pressure, the central venous pressure, the lung water content, and the whole body water content, a relation between an average pixel value in the heart region calculated from a chest dynamic image (a frame image) radiographed in a predetermined cardiac phase and each of the pulmonary arterial pressure, the arterial pressure, the central venous pressure, the lung water content, and the whole body water content, and a relation between a difference value between a maximum value and a minimum value in one cardiac cycle of the average pixel value in the heart region and each of the pulmonary arterial pressure, the arterial pressure, the central venous pressure, the lung water content, and the whole body water content can also be respectively represented by linear formulas. However, coefficients of the linear formulas were different from one another.

As a result of the examination, it has been found that a relation between a diameter (for example, a maximum of a diameter in the horizontal direction) of the heart region of a chest dynamic image (a frame image) radiographed in a predetermined cardiac phase and each of the pulmonary arterial pressure, the arterial pressure, the central venous pressure, the lung water content, and the whole body water content and a relation between a difference value between a maximum value and a minimum value in one cardiac cycle of the diameter of the heart region of the chest dynamic image and each of the pulmonary arterial pressure, the arterial pressure, the central venous pressure, the lung water content, and the whole body water content can also be represented by linear formulas. However, coefficients of the linear formulas were different from one another.

The console 2 calculates, based on these examination results, a blood pressure, a pulmonary arterial pressure, an arterial pressure, a central venous pressure, a lung water content, and a whole body water content from the chest dynamic image. In this embodiment, as an example, the cardiac function measurement processing B for calculating a blood pressure, a pulmonary arterial pressure, an arterial pressure, a central venous pressure, a lung water content, and a whole body water content using, as a parameter, an average of an average pixel value in the lung region in a maximum expiratory level is explained.

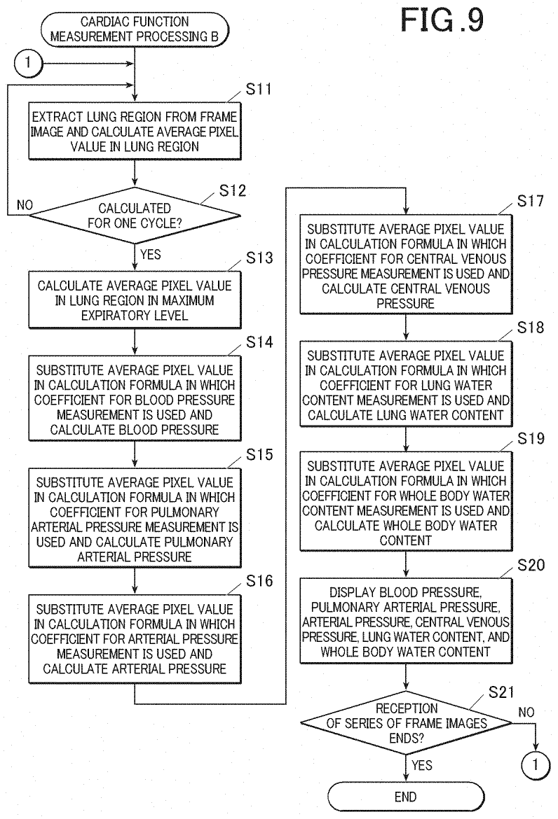

A flow of the cardiac function measurement processing B is shown in FIG. 9. The cardiac function measurement processing B is executed by cooperation of the controller 21 and a program stored in the storage 22.

First, the controller 21 extracts a lung region from a received frame image and calculates an average pixel value in the extracted lung region (step S11).

In step S11, first, the controller 21 extracts a lung region from a received frame image. The controller 21 calculates a threshold according to a discriminant analysis from a histogram of pixel values of pixels and primarily extracts a region of a signal higher than the threshold as a lung region candidate. Subsequently, the controller 21 performs edge detection near a boundary of the primarily-extracted lung region candidate and extracts, along the boundary, a point where an edge is the largest in a small region near the boundary. Then, the boundary of the lung region can be extracted.

Subsequently, the controller 21 determines based on a temporal change of the calculated average pixel value whether an average pixel value in the lung region is calculated from a frame image for one respiratory cycle (step S12). If determining that an average pixel value in the lung region is not calculated from the frame image for one respiratory cycle (NO in step S12), the controller 21 returns to step S11.

If determining that an average pixel value in the lung region is calculated from the frame image for one respiratory cycle (Yes in step S12), the controller 21 acquires an average pixel value in the lung region in the maximum expiratory level (step S13). The average pixel value in the lung region in the maximum expiratory level is a lowest value among average pixel values in the lung region in frame images for one respiratory cycle.

Subsequently, the controller 21 acquires a coefficient for blood pressure measurement corresponding to the patient information (the age and the physique) of the subject H from the coefficient table of the storage 22, substitutes the average pixel value calculated in step S13 in a calculation formula in which the acquired coefficient is used, and calculates a blood pressure of the subject H (step S14).

Subsequently, the controller 21 calculates a coefficient for pulmonary arterial pressure measurement corresponding to the patient information of the subject H from the coefficient table of the storage 22, substitutes the average pixel value acquired in step S13 in a calculation formula in which the acquired coefficient is used, and calculates a pulmonary arterial pressure of the subject H (step S15).

Subsequently, the controller 21 calculates a coefficient for arterial pressure measurement corresponding to the patient information of the subject H from the coefficient table of the storage 22, substitutes the average pixel value acquired in step S13 in a calculation formula in which the acquired coefficient is used, and calculates an arterial pressure of the patient H (step S16).

Subsequently, the controller 21 calculates a coefficient for central venous pressure measurement corresponding to the patient information of the patient H from the coefficient table of the storage 22, substitutes the average pixel value acquired in step S13 in a calculation formula in which the acquired coefficient is used, and calculates a central venous pressure of the subject H (step S17).

Subsequently, the controller 21 acquires a coefficient for lung water content measurement corresponding to the patient information of the subject H from the coefficient table of the storage 22, substitutes the average pixel value calculated in step S13 in a calculation formula in which the acquired coefficient is used, and calculates a lung water content of the subject H (step S18).

Subsequently, the controller 21 acquires a coefficient for whole body water content measurement corresponding to the patient information of the patient H from the coefficient table of the storage 22, substitutes the average pixel value calculated in step S13 in a calculation formula in which the acquired coefficient is used, and calculates a whole body water content of the subject H (step S19).

The calculated evaluation values are desirably normalized by a correction coefficient based on a heart area or a lung area calculated from the chest dynamic image or the height or the weight of the subject H.

Subsequently, the controller 21 displays the calculated blood pressure, the calculated pulmonary arterial pressure, the calculated arterial pressure, the calculated central venous pressure, the calculated lung water content, and the calculated whole body water content on the display 24 (step S20).

In this embodiment, every time a frame image in the maximum expiratory level is received from the FPD cassette 4, a blood pressure, a pulmonary arterial pressure, an arterial pressure, a central venous pressure, a lung water content, and a whole body water content are calculated and displayed on the display 24 (the display is updated). That is, the blood pressure, the pulmonary arterial pressure, the arterial pressure, the central venous pressure, the lung water content, and the whole body water content can be measured and displayed substantially on a real-time basis.

As a display example in step S20, for example, the controller 21 sequentially displays received frame images and displays the calculated blood pressure, the calculated pulmonary arterial pressure, the calculated arterial pressure, the calculated central venous pressure, the calculated lung water content, and the calculated whole body water content as numerical values. Alternatively, the controller 21 may display the calculated blood pressure, the calculated pulmonary arterial pressure, the calculated arterial pressure, the calculated central venous pressure, the calculated lung water content, and the calculated whole body water content as time-series graphs. Alternatively, the controller 21 may display the heart region of the displayed frame image in a color corresponding to a value of the blood pressure, the pulmonary arterial pressure, the arterial pressure, the central venous pressure, the lung water content, or the whole body water content. The user may be able to set in a color corresponding to which evaluation value the heart region of the frame image is displayed.

Subsequently, the controller 21 determines whether reception of a series of frame images of a dynamic image from the FPD cassette 4 has ended (step S21). For example, when a transmission end of the frame images of the dynamic image is notified from the FPD cassette 4, the controller 21 determines that the reception of the series of frame images of the dynamic image has ended.

If determining that the reception of the series of frame images of the dynamic image has not ended (NO in step S21), the controller 21 returns to step S11.

If determining that the reception of the series of frame images of the dynamic image has ended (YES in step S20), the controller 21 ends the cardiac function measurement processing B.

In this way, in the cardiac function measurement processing B, the controller 21 extracts a lung region from the frame images of the chest dynamic image and calculates a blood pressure by substituting an average for one respiratory cycle of an average pixel value calculated from the extracted lung region in a calculation formula in which a coefficient corresponding to the age and the physique of the patient is used. The controller 21 changes the coefficient of the calculation formula to calculate a pulmonary arterial pressure, an arterial pressure, a central venous pressure, a lung water content, and a whole body water content. Therefore, rather than detecting a hardly recognizable microstructure such as a pulsating part in a vessel or a local portion of the heart from the frame images of the chest dynamic image and using a measurement value and a pixel value of the microstructure as in the past, the blood pressure, the pulmonary arterial pressure, the arterial pressure, the central venous pressure, the lung water content, and the whole body water content are calculated using a pixel value of an easily recognizable lung region. Therefore, it is possible to accurately calculate the blood pressure, the pulmonary arterial pressure, the arterial pressure, the central venous pressure, the lung water content, and the whole body water content.

In the cardiac function measurement processing B, an example is explained in which an average pixel value in the lung region in the maximum expiratory level is calculated from the frame images of the chest dynamic image sequentially transmitted from the FPD cassette 4 and a blood pressure, a pulmonary arterial pressure, an arterial pressure, a central venous pressure, a lung water content, and a whole body water content are calculated using the calculated average pixel value. However, a parameter for calculating the blood pressure, the pulmonary arterial pressure, the arterial pressure, the central venous pressure, the lung water content, and the whole body water content is not limited to the average pixel value in the lung region. For example, a coefficient used in a calculation formula for calculating each of a blood pressure, a pulmonary arterial pressure, an arterial pressure, a central venous pressure, a lung water content, and a whole body water content from a value of any one of the following parameters calculated from the chest dynamic image and verified by an experiment may be stored in the coefficient table of the storage 22. The controller 21 may acquire a coefficient for measurement of each of a blood pressure, a pulmonary arterial pressure, an arterial pressure, a central venous pressure, a lung water content, and a whole body water content corresponding to the patient information of the subject H from the coefficient table of the storage 22, substitute the value of the parameter calculated from the chest dynamic image in a calculation formula in which the acquired coefficient is used, and calculate each of a blood pressure, a pulmonary arterial pressure, an arterial pressure, a central venous pressure, a lung water content, and a whole body water content. The following parameters are calculated from an area, a diameter, a pixel value of a heart region or a pixel value of a lung region extracted from the frame image. Since the calculation of the parameters does not involve extraction and recognition of a microstructure, it is possible to accurately calculate a blood pressure, a pulmonary arterial pressure, an arterial pressure, a central venous pressure, a lung water content, and a whole body water content.

When a parameter based on the heart area or the pixel value of the heart region is used, in order to reduce an error due to a body motion or respiration, when performing dynamic radiographing, it is desirable to instruct the subject H to hold breath and perform the dynamic radiographing in a breath-held state.

### <Parameter Examples>

A heart area in a predetermined cardiac phase (for example, a systole period, a diastole period, or an intermediate period of the systole period and the diastole period)
An average value in one cardiac cycle of the heart area
A difference value between a maximum value and a minimum value in one cardiac cycle of the heart area
An average in one respiratory cycle of an average pixel value in the lung region
An average pixel value in the lung region in a predetermined respiratory phase (for example, a maximum expiratory level, a maximum inspiratory level, and an intermediate level between the maximum expiratory level and the maximum inspiratory level)
A difference value between a maximum value and a minimum value in one respiratory cycle of the average pixel value in the lung region
An average in one cardiac cycle of an average pixel value in the heart region
An average pixel value in the heart region of a predetermined cardiac phase (for example, a systole period, a diastole period, and an intermediate period between the systole period and the diastole period)
A difference value between a maximum value and a minimum value in one cardiac period of the average pixel value in the heart region
An average in one cardiac cycle of the diameter of the heart region
A diameter of the heart region in a predetermined cardiac phase (for example, a systole period, a diastole period, and an intermediate period between the systole period and the diastole period)
A difference value between a maximum value and a minimum value in one cardiac cycle of the diameter of the heart region

A transfusion amount may be calculated based on any one of the parameters and a calculation formula in which a coefficient experimentally calculated in advance is used.

In the second embodiment, the coefficient used in the calculation formula for calculating an evaluation value of a cardiac function and an evaluation value of a water content is experimentally calculated in advance and stored in the storage 22. However, the evaluation values may be measured from the subject with other tests (for example, a test by a manometer in the case of the blood pressure, a test by a pulmonary-artery catheter in the case of the pulmonary arterial pressure, a test by a circulation dynamic monitor in the case of the arterial pressure and the lung water content, a test by a central venous catheter in the case of the central venous pressure, and a test of a transfusion amount, a urine amount, and a bleeding amount in the case of the whole body water content). Coefficients for calculating the evaluation values may be calculated based on parameters calculated from the measured evaluation values and the frame image during the measurement.

As explained above, the controller 21 of the console 2 extracts a heart region or a lung region from a dynamic image obtained by radiographing a dynamic state of a chest, calculates an evaluation value of a cardiac function based on an area, a diameter, or a pixel value of the extracted heart region or a pixel value of the extracted lung region, and causes the display 24 to display the evaluation value.

Therefore, it is unnecessary to perform extraction and recognition of a microstructure such as a blood vessel from a low-quality dynamic image in order to calculate the evaluation value of the cardiac function. Therefore, it is possible to accurately calculate the evaluation value of the cardiac function.

The description content in the embodiments is a preferred example of the dynamic image analysis system according to the present invention and is not limited to this.

For example, the stroke volume and the cardiac output are calculated in the first embodiment and the blood pressure, the pulmonary arterial pressure, the arterial pressure, and the lung water content are calculated in the second embodiment. However, the console 2 may calculate all of the stroke volume, the cardiac output, the blood pressure, the pulmonary arterial pressure, the arterial pressure, and the lung water content, may calculate any one of the stroke volume, the cardiac output, the blood pressure, the pulmonary arterial pressure, the arterial pressure, and the lung water content, or may calculate any two or more of the stroke volume, the cardiac output, the blood pressure, the pulmonary arterial pressure, the arterial pressure, and the lung water content.

In the embodiments, the coefficient of the calculation formula for calculating the evaluation value of the cardiac function from the parameters is stored in the storage 22. However, the calculation formula itself may be stored in the storage 22. A table indicating a correspondence relation between values of the parameters and the evaluation value of the cardiac function may be stored in the storage 22 and the evaluation value of the cardiac function may be calculated with reference to the table.

For example, when measuring evaluation values (a heart rate, a stroke volume, a cardiac output, a blood pressure, a pulmonary arteria pressure, an arterial pressure, a central venous pressure, and the like) of the cardiac function using the average pixel value of the heart region as a parameter, the controller 21 may divide the heart region into an atrium and a ventricle and measure an evaluation value of the cardiac function of each of the atrium and the ventricle.

As a method of dividing the heart region into the atrium and the ventricle, for example, there is a method of determining the atrium and the ventricle from timing of a blood flow waveform. For example, a plurality of ROIs are disposed on the heart region with reference to timing when blood is filled in the lung (a pixel value decreases) in a temporal change of a pixel value (an average pixel value) due to a blood flow in the lung region. A position of an ROI where the pixel value increases (the blood decreases) at the same timing as the reference timing is divided as the ventricle and a position of an ROI where pixel value decreases (the blood increases) at the same timing as the reference timing can be divided as the atrium.

The temporal change of the pixel value due to the blood flow of the lung region can be acquired by, for example, filtering a temporal change direction of the pixel value of the lung region with a bypass filter (for example, a cutoff frequency 0.80 Hz) of a time direction. The filtering may be performed using a bandpass filter (for example, a low-pass cutoff frequency 0.8 Hz and a high-pass cutoff frequency 2.4 Hz) in the time direction with respect to the temporal change of the pixel value of the lung region.

By measuring the evaluation value (the heart rate, the stroke volume, the cardiac output, the blood pressure, the pulmonary arterial pressure, the arterial pressure, the central venous pressure, and the like) of the cardiac function of each of the atrium and the ventricle in this way, the user is capable of grasping the cardiac function of each of the atrium and the ventricle and, when, for example, the cardiac function is deteriorated, specifying a part of the deterioration of the cardiac function.

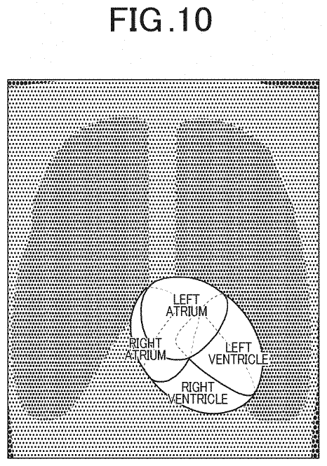

As shown in FIG. 10, in a chest dynamic image, the left heart is located on the upper side of a major axis of the heart region and the right heart is located on the lower side of the major axis. Therefore, when the evaluation value of the cardiac function is measured using the heart region and the average pixel value of the heart region as parameters, the evaluation value of the cardiac function may be measured by setting the upper side of the major axis of the heart region as the left heart and setting the lower side of the major axis as the right heart and distinguishing the left heart and the right heart. Consequently, the user is capable of grasping the cardiac function of each of the right heart and the left heart and, when, for example, the cardiac function is deteriorated, specifying a part of the deterioration of the cardiac function.

The distinction of the atrium and the ventricle and the distinction of the left heart and the right heart may be combined to distinguish the left atrium, the left ventricle, the right atrium, and the right ventricle to measure the evaluation value of the cardiac function of each of the left atrium, the left ventricle, the right atrium, and the right ventricle. Consequently, when, for example, the cardiac function is deteriorated, the user is capable of specifying a part of the deterioration of the cardiac function more in detail.

Before an operation and during the operation and/or after the operation, the controller 21 may perform the dynamic radiographing and the cardiac function measurement processing A and/or the cardiac function measurement processing B to acquire evaluation values of a cardiac function and evaluation values of a water content. The controller 21 may calculate, based on the evaluation value of the cardiac function and the evaluation value of the water content acquired before the operation, a difference value of the evaluation value of the cardiac function and the evaluation value of the water content during the operation and/or after the operation and display the difference value of the evaluation value and the evaluation value of the water content on the display 24. Consequently the user is capable of intuitively grasp a difference in the cardiac function and a difference in the water content before the operation and during the operation and/or after the operation.

In radiographing during the operation, it is likely that a medical instrument or a hand of a doctor is reflected on a radiographed frame image and affects measurement of a cardiac function and a water content. Therefore, the controller 21 desirably applies, to a received frame image, processing for removing a signal component of a shadow other than a subject (the chest of a human body) in a pixel value and then starts the processing in step S1 or step S11. The region of the shadow (a region of the medical instrument or the hand) other than the subject can be specified according to a shape and a pixel value of the region. For example, the region can be specified using a discriminator or the like constructed by machine learning such as threshold processing pattern recognition, or deep learning. The signal component of the shadow other than the subject can be estimated using, for example, a discriminator constructed by machine learning such as deep learning using an X-ray image obtained by radiographing a chest phantom and an X-ray image radiographed in a state in which a structure (the medical instrument or the like) other than the subject is disposed in the chest phantom. It is possible to remove the signal component of the shadow other than the subject by subtracting an estimated pixel value from a pixel value of a region recognized in a frame image.

In the embodiments, the controller 21 of the console 2 sequentially receives the frame images acquired during the dynamic radiographing and calculates the evaluation value of the cardiac function and the evaluation value of the water content. However, for example, when the calculated evaluation value of the cardiac function or the calculated evaluation value of the water content is in a predetermined range indicating that the evaluation value is in a satisfactory state, the controller 21 may control the radiation generator 1 to change (reduce) a radiation dose to be irradiated. This is because, when the evaluation value of the cardiac function is in the satisfactory state, since a rough evaluation value only has to be known, it is preferable to reduce exposure even if measurement accuracy slightly decreases. When the radiation dose to be irradiated is changed, a coefficient used for measurement is also changed according to the radiation dose.

In the embodiment, as an example, the dynamic image analysis system of the present invention is the system for round visit. However, the present invention is also applicable in a dynamic image analysis system that performs radiographing in a radiographing room and performs an analysis on an obtained dynamic image. By applying the dynamic image analysis system to the system for round visit, it is possible to perform radiographing in an outdoor environment such as a disaster site or a battle field and measure an evaluation value of a cardiac function and an evaluation value of a water content of a subject.

In the embodiments, the entire heart region or lung region is set as the ROI and the evaluation value of the cardiac function and the evaluation value of the water content are calculated based on the average pixel value in the ROI. However, the ROI may be set in a part of the heart region or the lung region and the evaluation value of the cardiac function and the evaluation value of the water content may be calculated based on the average pixel value in the ROI.

In the above explanation, the example is disclosed in which the hard disk, the semiconductor nonvolatile memory, or the like is used as the computer-readable medium of the program according to the present invention. However, the computer-readable medium is not limited to this example. As other computer-readable media, a portable recording medium such as a CD-ROM can be applied. As a medium for providing the data of the program according to the present invention via a communication line, a carrier wave is also applied.

Besides, the detailed configurations and the detailed operations of the apparatuses configuring the dynamic image analysis system can be changed as appropriate in a range not departing from the gist of the invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2018-217827, filed on Nov. 21, 2018, is incorporated herein by reference in its entirety.

What is claimed is:

1. A dynamic image analysis apparatus comprising a hardware processor that:
extracts a heart region or a lung region from a dynamic image obtained by radiographing a dynamic state of a chest of a subject and
calculates, based on an area, a diameter, or a pixel value of the extracted heart region or a pixel value of the extracted lung region, an evaluation value of a cardiac function or an evaluation value of a water content of the subject.

2. The dynamic image analysis apparatus according to claim 1, wherein the hardware processor calculates, as the evaluation value of the cardiac function, a heart rate, a stroke volume, a cardiac output, a blood pressure, a pulmonary arterial pressure, an arterial pressure, or a central venous pressure and calculates, as the evaluation value of the water content, a lung water content or a whole body water content.

3. The dynamic image analysis apparatus according to claim 1, wherein the hardware processor calculates the evaluation value of the cardiac function or the evaluation value of the water content based on an area, a diameter, or an average pixel value of the extracted heart region in a predetermined cardiac phase.

4. The dynamic image analysis apparatus according to claim 1, wherein the hardware processor calculates the evaluation value of the cardiac function or the evaluation value of the water content based on a difference value between a maximum value and a minimum value in one cardiac cycle of the area, the diameter, or the average pixel value of the extracted heart region.

5. The dynamic image analysis apparatus according to claim 1, wherein the hardware processor calculates the evaluation value of the cardiac function or the evaluation value of the water content based on an average in one cardiac cycle of the area, the diameter, or the average pixel value of the extracted heart region.

6. The dynamic image analysis apparatus according to claim 1, wherein the hardware processor calculates the evaluation value of the cardiac function or the evaluation value of the water content based on an average pixel value of the extracted lung region of a predetermined respiratory phase.

7. The dynamic image analysis apparatus according to claim 1, wherein the hardware processor calculates the evaluation value of the cardiac function or the evaluation value of the water content based on a difference value between a maximum value and a minimum value in one respiratory cycle of an average pixel value of the extracted lung region.

8. The dynamic image analysis apparatus according to claim 1, wherein the hardware processor calculates the evaluation value of the cardiac function or the evaluation value of the water content based on an average in one respiratory cycle of an average pixel value of the extracted lung region.

9. The dynamic image analysis apparatus according to claim 1, wherein the hardware processor divides the extracted heart region into an atrium and a ventricle and, when calculating the evaluation value of the cardiac function based on an average pixel value of the heart region, calculates an evaluation value of the cardiac function of each of the atrium and the ventricle based on an average pixel value of a region divided as the atrium and an average pixel value of a region divided as the ventricle.

10. The dynamic image analysis apparatus according to claim 1, wherein the hardware processor divides the extracted heart region into a left heart and a right heart and, when calculating the evaluation value of the cardiac function based on an average pixel value of the heart region, calculates an evaluation value of the cardiac function of each of the left heart and the right heart based on an average pixel value of a region divided as the left heart and an average pixel value of a region divided as the right heart.

11. The dynamic image analysis apparatus according to claim 1, wherein the hardware processor normalizes the calculated evaluation value of the cardiac function with a correction coefficient based on an area of the heart region, an area of the lung region, and height or weight of the subject.

12. The dynamic image analysis apparatus according to claim 1, wherein the hardware processor includes a display device that displays the calculated evaluation value of the cardiac function or the calculated evaluation value of the water content.

13. The dynamic image analysis apparatus according to claim 1, wherein the hardware processor performs a difference analysis of an evaluation value of the cardiac function or an evaluation value of the water content calculated from a dynamic image radiographed before an operation and an evaluation value of the cardiac function or an evaluation value of the water content calculated from a dynamic image radiographed during the operation or after the operation.

14. The dynamic image analysis apparatus according to claim 1, wherein the hardware processor removes a signal component of a shadow other than the subject from the dynamic image and performs the extraction and the calculation based on the dynamic image from which the signal component of the shadow other than the subject is removed.

15. The dynamic image analysis apparatus according to claim 1, wherein the hardware processor sequentially performs the extraction and the calculation on dynamic images sequentially acquired by a radiographing apparatus to calculate an evaluation value of the cardiac function or an evaluation value of the water content and controls, based on the calculated evaluation value of the cardiac function or the calculated evaluation value of the water content, a radiation dose irradiated by the radiographing apparatus.

16. A dynamic image analysis system comprising:
the dynamic image analysis apparatus according to claim 1; and
a radiographing apparatus that radiographs the dynamic image.
